(19) United States
(12) Patent Application Publication
(10) Pub. No.: US 2011/0240675 A1
(43) Pub. Date: Oct. 6, 2011

(54) Defensive spray container holster

(76) Inventor: Kenneth J. McDoanald, Sussex, NJ (US)

(21) Appl. No.: 12/798,336

(22) Filed: Apr. 2, 2010

(51) Int. Cl. B05B 15/06; B05B 11/04

(52) U.S. Cl. 222/180; 222/212; 222/175; 222/563

(57) ABSTRACT

The invention is a defensive retainer bottle combination. The bottle contains a defensive spray that immediately immobilizes a person when sprayed upon at the upper extremities of the person. The retainer is made of molded plastic and has upper and lower plates with upturned lips to retain a bottle placed there between. The retainer further has upper and lower springy retainer clips that assure a sure retention of the bottle within the retainer until an emergency requires the use of the bottle whereby a hard pull on the bottle by a hand will dislodge the bottle and make it ready for use. Once the bottle is filled with a defensive fluid. The bottle is inserted into the retainer with a top screw cap first and is then securely caught between the retention clips. The top of the screw cap has an aperture or hole therein into which a nipple penetrates to leak-proof retain the liquid in the bottle. The nipple is part of a rubber plug that is screwed into the top of the retainer.

### CROSS REFERENCE TO RELATED APPLICATION

This application is a utility application of the prior filed provisional application having a Ser. No.______ and filing date of:______ (not available at this time)

### STATEMENT REGARDING FED SPONSORED R & D

None

### REFERENCE TO MICROFICHE APPENDIX

None

### BACKGROUND OF THE INVENTION

This invention is a variation or an improvement over applicant's prior patent No. 5,826,796 and pertains to a container having a defensive liquid therein. By defensive liquid is meant a liquid that immediately will disable a person, is the person is an attacker when dispensed onto the face of the person or attacker. The liquid will disable the person for a certain period of time so that said person is disabled for some time and is prevented escaping and can be held subdued until the proper authorities can take appropriate measures. in view of the events that happened on September 11 in New York City and Washington D.C., if such a spray container had been onboard in any of the planes involved, most of the resulting tragedies could have been avoided. The spray container, because of its size, could have been in the pockets of the pilot, copilot or any of the flight attendants, that is, because of its unobtrusive nature. Recently, there have been quite some discussions whether or others on board of an air plane should weapons such as guns. It is believed that this disabling spray container would be a much better safeguard. The inventor is fully aware that the FAA prohibits any kind of pressurized defensive containers on board of an aircraft, such as maze or pepper spray. Because of the fact that the disclosed defensive spray container is not pressurized at all, but is activated by hand pressure, the would be much more effective because it is controlled by the person using it and not by the pressure medium within the container.

### BRIEF SUMMARY OF THE INVENTION

The spray bottle of this disclosure is different from the prior patent No. 5,826,796 and the disclosure of the co-pending application in that the spray container of this application does not have a screw cap to be manipulated or to be knocked off when a use is desired but the top of the spray bottle is sealed within a holster which has a seal therein in which it is carried but is ready for use when taken out of the holster and when the need arises. The use of a holster is preferred in many situations because the presence of the spray bottle on a person can be concealed much better under a jacket through the use of the holster or a trouser or skirt belt. The spray container is also much more readily available and instantaneously much quicker ready for use.

### BRIEF DESCRIPTION OF THE DRAWINGS

FIG. 1 is a cross-sectional view through spray container;

FIG. 2 is a perspective of the of the spray container in a holster;

FIG. 3 is a detailed view of the seal on the top of the spray container

### DETAILED DESCRIPTION OF THE INVENTION

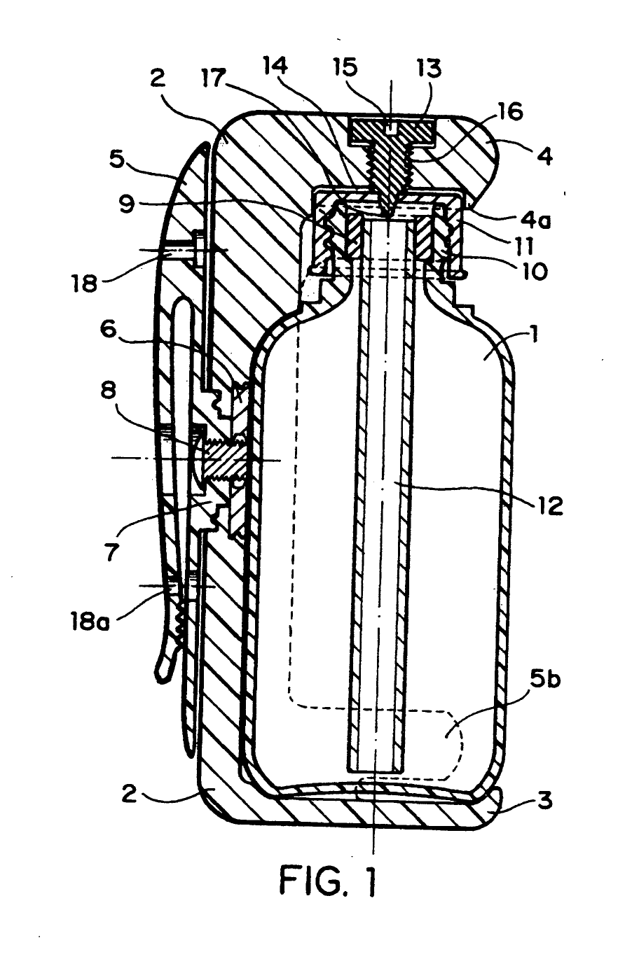

In FIG. 1 the bottle or container is shown as 1. The container is held in place in the holster or retainer designated as 2. The retainer has a bottom 3 and a top 4. The retainer is molded from a plastic material which renders the retainer rigid, yet somewhat flexible. This is necessary so that the container 1 can be retained within the retainer or holster 2. It is to be noted that the forward end of the retainer base has an upturned lip which prevents the bottle from sliding out. The bottle must be pulled out and cannot dislodge by itself. The same retainer lip is found at 4a at the retainer top 4. On one side of the bottle 1 there is shown a retainer belt clip 5. Within the retainer 2 there is embedded a circular retaining plate 6 which can rotate within the retainer 2. The belt clip 5 is fastened to this retainer plate 6 by way of screw 8 which itself passes through a rotating retainer plate 7 which is integral with the belt clip 5. Depending on how the retainer screw 8 is tightened or loosened, this fact will control the degree of force by which the belt clip can be turned relative to the bottle 1 in the retainer 2. This will control the vertical attitude by which the container 1 can be adjusted at a most effective position on a person or in a location where the container is located in a fixed position on some implement.

Within the neck of the bottle 1 is located a seal 9 which snugly fits inside the neck and at the same time carries a rigid tube 12 which extends to almost the bottom of the bottle 1. This arrangement assures that all of the liquid contained within the bottle can be expelled to almost the whole content.

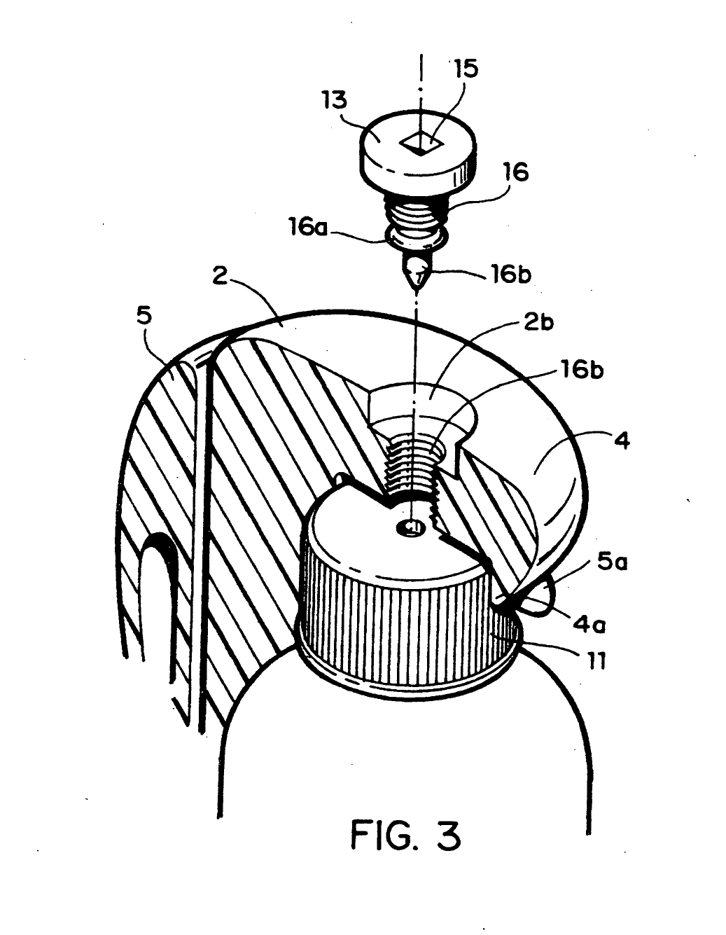

The bottle neck has an exterior screw thread 10 which will receive the interiorly threaded screw cap 11 thereon. In order to seal the liquid within the bottle, a rubber plug 13 is provided which has exterior threads 16 thereon to be screwed into an opening on the top of the bottle cap 11. At 14 is shown a space for the rubber plug 13 so that the nipple 17 on the rubber plug 13 can penetrate deep enough into the bottle cap 11 to assure an effective seal. On top of the rubber plug 13 there is provided a manner 15 of applying a tool so that the rubber plug 13 can be forced into the opening 2b (FIG. 3) in the upper retaining top 4 of the retainer 2.

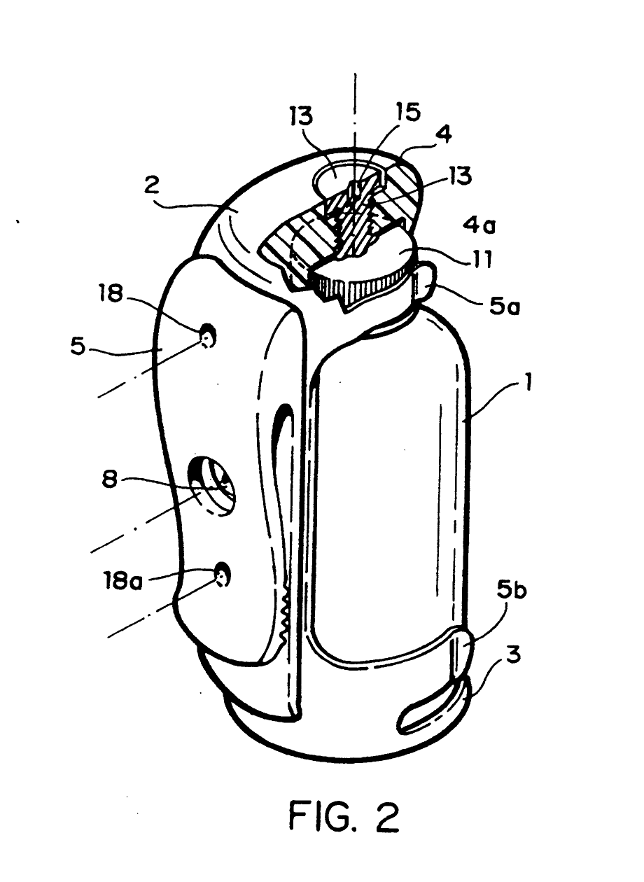

FIGS. 1 and 2 illustrate a method of fastening the holster or belt clip 5 to a surface other than the body of a person. This surface could be a dash of a vehicle or a boat Of anywhere in the cockpit of an air plane so that the container is in an easy reach of a person desiring to use the container in an emergency but the person does not have to carry the spray container on his or her body. It could also be in addition to the person carrying a spray container already in his or her pocket. It all depends on the specific circumstances at hand.

To this end, there are provided through holes through the clip 18a and the base 18 of the retainer 5. Prior to installing the retainer bottle combination on any desired surface, the retainer clip 5 should be turned around the retainer plate to a position so that the retainer clip 5 ends up in a position which is normal to the retainer 2. This way the retainer screws (not shown) may pass through the holes 18 and 18a into a supporting surface. Thereafter the retainer may be turned into any desired position.

Turning now to FIG. 2 which is a perspective view of the retainer bottle combination. The same reference characters have been applied as were in FIG. 1. This FIG. 2 makes clearer how the bottle 1 is retained in the retainer 2. To this end, springy clips have been included in the mold of the retainer 2. There is an upper clip 5a and a lower clip 5b. The bottle is merely inserted into these two clips 18a and 18b and securely maintained therein until use is required whereby a sharp pull by a hand will dislodge the spray bottle which is immediately ready for use.

Turning now to FIG. 3 which illustrates the cap sealing combination in an exploded view. Again like reference characters have been applied as in FIGS. 1 and 2. The bottle cap 11 can clearly be seen at 2. Also the recess 2b in the top 4 of the retainer is more clearly shown. At one point a part of the clip 5a is shown as embracing the bottle cap 11.

In operation, the rubber plug 13 is inserted into the recess 2b and by of a tool engaging the recess 15, the rubber plug 13 is screwed into the top 4 of the retainer 2. When fully seated the sealing ring 16a on the rubber plug 13 will seal leak proof against the top of the screw cap and the nipple 16b which will penetrate into the opening of the cap top to further assure a complete sealing.

What we claim is:

1. A defensive bottle retainer combination comprising:
a molded retainer having a bottle retained therein,
said retainer comprising upper and lower retainer plates , each having upturned or down turned lips thereon, respectively, receiving said bottle therein,
said bottle having a top screw cap and an aperture on top of said screw cap, said screw cap, in its neck further having an interior seal therein, said seal carrying a downwardly extending tube therein,
a rubber plug is installed in a top of said retainer having means for sealing said aperture on top of said screw cap.

2. The defensive bottle retainer combination of claim 1 including upper and lower retaining clips surrounding upper and lower regions of said bottle.

3. The defensive bottle retainer combination of claim 1 including a belt clip attached to said retainer.

4. The defensive bottle retainer combination of claim 1 including a belt clip attached to said retainer, means for rotatably supporting said belt clip on said retainer.

5. The defensive bottle retainer of claim 3 including means for mounting said belt clip on an external surface.
